(19) United States
(12) Patent Application Publication
(10) Pub. No.: US 2023/0303938 A1
(43) Pub. Date: Sep. 28, 2023

(54) SYSTEM FOR WASHING BIOLOGICAL WASTE TO RECOVER SAME AS SOLID BIOFUEL

(71) Applicant: Sociedad de Inversiones y Rentas Tricao S.p.A., Santiago (CL)

(72) Inventor: Jose Antonio CARABALL UGARTE, Valparaiso (CL)

(73) Assignee: Sociedad de Inversiones y Rentas Tricao S.p.A., Santiago (CL)

(21) Appl. No.: 18/191,381

(22) Filed: Mar. 28, 2023

Related U.S. Application Data
(63) Continuation of application No. PCT/CL2020/050112, filed on Oct. 2, 2020.

(51) Int. Cl. C10L 5/42; C10L 5/36

(52) U.S. Cl. CPC C10L 5/42; C10L 5/361; C10L 5/363; C10L 2200/0469; C10L 2290/08; C10L 2290/545; C10L 2290/547

(57) ABSTRACT

This development describes a system, a method, and specific products for washing biological waste, preferably animal manure, particularly cattle manure, particularly biological waste with high silica content and agro-industrial and forestry waste products to obtain a purified lignocellulosic product with a high calorific value that, when burned, releases low concentrations of harmful gases and does not generate or generates little vitrification inside.

### CLAIM OF PRIORITY AND INCORPORATION BY REFERENCE

This application claims the priority of International Patent Application No. PCT/CL2020/050112 as a continuation application, filed on Oct. 2, 2020, which is hereby incorporated by reference in its entirety.

The contents of International Patent Application No. PCT/CL2017/000009 are incorporated by reference herein in its entirety.

### BACKGROUND

### Field of Invention

This method makes it possible to obtain a product with a high calorific value, low emission of toxic gases and ash, and low vitrification in the oven or stove as it is calcined, which corresponds in particular to lignin, cellulose, hemicellulose and derivatives thereof, with great energy savings in the process and low intensity of labor during operation.

The present development presents a system, a method and a biomass or derivative product with a high calorific value that is extremely efficient in contributing to the reduction of greenhouse gas emissions. In practice, it allows the replacement of fossil sources by biomass. Significant energy savings and efficiencies in labor intensity are generated during its production process.

The field of application of this system, method and product includes the treatment of waste (solid and semi-solid) of biological origin, particularly in the livestock industry, biomass recovery systems for energy generation and biomass drying and preparation processes.

### Description of the Related Art

In any industry that works with or emits biological waste, in particular in the management of slurry (cattle manure) in the livestock industry, which is a difficult problem to address, since it is a residue that can contaminate properties, groundwater and the environment in general. Likewise, there is concern regarding the sanitary management of agricultural manure in these industries.

Particularly, the manure generated can cause negative environmental impacts if there is no control of its storage, transportation or application, due to the emission of polluting gases into the atmosphere and the accumulation of micro- and macro-nutrients in the soil and in surface water bodies as the final destination for such manure.

The livestock sector is responsible for 18% of greenhouse gas emissions measured in CO₂ equivalents. This is a higher contribution than that of transport. The livestock sector is responsible for 9% of anthropogenic emissions of CO₂. Most of this is derived from changes in land use, especially due to the deforestation caused by the expansion of grasslands for fodder. In addition, stabled animals, especially cattle, are responsible for the emission of gases with much greater potential to warm the atmosphere. This sector emits 37% of anthropogenic methane (with 84 times the global warming potential [GWP] of CO₂) produced in the most part by the enteric fermentation of ruminants. It emits 65% of anthropogenic nitrous oxide (with 296 times the global warming potential of CO₂), mostly through manure. Livestock are also responsible for nearly two thirds (64%) of anthropogenic ammonia emissions, which significantly contribute to acid rain and ecosystem acidification. The reduction of these high levels of emissions through actions by the livestock sector presents opportunities for climate change mitigation.

### Greenhouse Gas Emissions from the Agricultural Sector

The livestock sector is responsible for 18% of greenhouse gas emissions measured in CO₂ equivalents. This is a higher contribution than that of transportation sectors.

It should be noted that the livestock sector is responsible for 20% of terrestrial animal biomass. In view of the ongoing green gas emissions from the livestock industry, systems, and methods for the treatment of manure, slurry and other residues of biological origin are desired, where such systems and methods have low energy consumption, allow for the manufacture of products with a high calorific value, low concentrations of silica within the ash, low concentration of nitrogen, and which when burned release low concentrations of harmful gases. It is also desired that such systems and methods produce intermediate products that serve as an excipient base for other synthesis routes, such as products high in lignin but with traces of cellulose, hemicellulose, and similar derivatives.

### Water Contamination

According to the Food and Agricultural Organization (“FAO”) of the United Nations, the livestock sector is a key factor in the increase of water use since it is responsible for 8% of the world consumption of this resource, mainly for the irrigation of fodder crops. In addition, it is probably the highest source of water pollution and contributes to eutrophication, the “dead” zones in coastal areas, coral reef degradation, the appearance of human health problems, antibiotic resistance, and many other problems. The main sources of pollution come from animal waste, antibiotics and hormones, the chemicals used in tanneries, fertilizers and pesticides used on fodder crops, and eroded grassland sediments. The effect of the animal waste on the environment makes finding ways to reuse and decontaminate this liquid waste a high priority.

### DESCRIPTION OF THE STATE OF THE ART

The FAO and the Netherlands have found that quantities of mixed manure (including feces and urine but excluding sewage) produced by livestock annually are:
Adult dairy cows: 23,000 L
Feeder cattle (1-2 years) 10,000 L
Sows with piglets 4,700 L
Feeder pigs 1,100 L
Broilers 11 L
Layers 87 L

Particularly, in the livestock industry, both manure and slurry generally correspond to a mixture of the animals' fecal matter with their urine and eventually the bedding material, the latter being understood as the resting and feeding place for the animals.

The manure, in addition to containing fecal matter and urine, can consist of other elements, such as those present in the bedding, generally straw, and also sawdust, wood shavings, chemical products, sand, shells, bran, remains of the livestock feed, and water.

Manure is normally applied on the ground, providing organic matter to the soil. The contribution of organic matter entails an improvement of the soil structure and increases its water retention capacity.

On the other hand, manure is a rich source of plant nutrients (N, P, K). The amount of nutrients and minerals present in manure depends on several factors, including for example: Type of livestock, livestock feed (which is directly related to the destination of the animal) and environmental conditions.

One of the elements that makes up manure is vegetable residue of different kinds, among which we can highlight lignocellulose and its derivatives. Lignocellulose is a complex material that constitutes the main structure of plant cell walls and is composed mainly, in the case of cereals, of cellulose (40-50%), hemicellulose (25-30%) and lignin (15-20%), in the case of grasses (forage consumed by ruminants), the average percentages are divided into cellulose (24-39%), hemicellulose (11-39%) and lignin (4-11%). Cellulose is a homogeneous linear polymer with 7,000 to 15,000 glucose units linked by glycosidic bonds that are stabilized with hydrogen bonds. Hemicellulose is a branched or linear heteropolymer of between 200-400 units of different pentoses, hexoses and uronic acids with an amorphous structure. Lignin is a cross-linked amorphous polymer of three units of p-coumaroyl phenylpropane, coniferyl, and alcohol. In order to decrease the world's dependence on fossil fuels, there are alternative sustainable energy sources and chemical products to be exploited. One of these possible sources is lignocellulose biomass such as wood or agricultural residues (Brethauer, S., & Studer, M. H. (2015). Biochemical Conversion Processes of Lignocellulosic Biomass to Fuels and Chemicals—A Review. CHIMIA International Journal for Chemistry, 69(10), 572-581).

Another element within the composition of slurry is made up of significant amounts of silica or derivatives thereof directly related to the amount of ash existing in its combustion. There are also other biological wastes with large amounts of silica in their structure, such as rice husks, which increase the percentage of silica in the final residue when they remain as part of the slurry (since silica cannot be digested) or simply as waste. It is important to make this reference to silica because when the finished products (briquettes, pellets or others) under any process modality are burned, the silica can reach temperatures above its melting point between 1100 and 1700° C., vitrifying the surfaces of boilers and ovens, causing them to lose heat exchange efficiency.

Another element in the composition of slurry is nitrogen, in the form of uric acid, such as ammoniacal nitrogen and other nitrogen derivatives. In bovine slurries the ratio is generally 50% uric acid and 50% ammoniacal nitrogen. As an example, one ton of nitrogen can be found in a 500 m3 well with a slurry having 4% solid mass. This concentration is important for soil nitrification, however, an end-product in the form of lignocellulose briquettes or pellets to be burned it is a problem. The problem is that the generation of N-Oxides (NOx) after a combustion process is already known. These N-Oxides tend, naturally, to rapidly oxidize, forming NO₃ and with atmospheric water to form HNO₃, a corrosive compound that is harmful to health and combustion equipment. Through another pathway, N₂O can be formed, a product that is highly damaging to the ozone layer and very chemically stable, with a half-life of over 170 years. In summary, the nitrogen derivatives and percentages that remain in the end product are extremely important at the time of burning because they carry toxic, corrosive and persistent by-products into the environment. The International Patent Application No. PCT/CL2017/00009 notes that about 0.61% w/w of nitrogen remains in the end product. It would be desirable to reduce this amount of nitrogen, approximately, by 30% w/w in the end product.

Among agricultural residues, bovine slurries are available at very low cost, but with a non-negligible handling and disposal cost. In order to reduce costs, the use of the product resulting from the treatment of these slurries without pre-treatment as fuel or fuel feedstock has been studied.

To date, techniques have been described for the detection and quantification of the content of the main components of manure (cellulose and protein), which use a solid/liquid physical separation method, manure hydrolysis and fungal culture to recover carbohydrates and proteins from the raw material in order to produce cellulase. In the case of obtaining lignin from agricultural residues and assessing its quality by means of different analytical methods, this is basically done by subjecting agricultural residues to a reduction to alkaline paste, treating it with formic acid and hydrogen peroxide, to then characterize the lignin by means of the Klason method, FT-IR spectroscopy, elemental analysis, thioacidolysis, SEC and different wet chemical methods.

Among the general techniques of mechanical separation in the liquid/solid fractions of manure most used in commercial plants is decantation by centrifugation, chemical treatment plus separation by belt press, rotary drum filter plus screw press, screw press plus vibration filter, sonication, and screw press only. It is considered that only mechanical separation techniques are included that use moving filters and presses.

In addition to the mechanical techniques for separating the liquid/solid fraction of manure, a separation method has been described by means of a coagulation-flocculation process, whose separation protocol consists of taking the raw manure stored at 4° C. and sieving it through a 1 mm mesh, then subjecting it to a coagulation/flocculation process according to the following conditions and steps: (1) for the coagulation process, coagulant solution was added and mixed for 2 min at 175 rpm; (2) for flocculation, a polyacrylamide solution is added and mixed for 13 minutes at 50 rpm; (3) the solid is allowed to form or settle during 2 hours, when the supernatant is extracted, or when for 5 minutes when a filter press is used to separate the solid fraction.

Another component that can be found in slurry is methane, a gas used as fuel. The yield and quality of this compound obtained from manure has been studied, with its results expressed according to the volatile solids (VS) parameter.

Additionally, there are processes for extracting manure products for other purposes. For example, a known process for extracting food products from animal manure comprising: forming a manure water slurry in a first pit and allowing said slurry to ferment; then separating said suspension into solid and liquid fractions, where the solid fraction comprises a silage component such as undigested fibers and grain; and where the liquid fraction comprises protein-rich nutrients and relatively indigestible dense mineral materials and fiber particles, ultimately separating said components and then processing the liquid fraction for use as a feed supplement containing relatively low amounts of indigestible minerals such as lignin and hemi-cellulose and fiber particles.

One known procedure for slurry treatment comprises: (a) solid/liquid physical separation in a liquid effluent containing slurry; (b) physical-chemical separation of the liquid fraction obtained in step (a), to obtain a solid and a liquid fraction; (c) electrocoagulation of the liquid fraction obtained in the step to obtain a solid and a liquid fraction; and (d) pelletizing the solid fractions obtained in steps (a), (b) and (c) in the presence of chemical or lignocellulosic materials. The solid agglomerate obtained from the pelletizing process offers a high calorific value in combustion, and the resulting liquid is left a very low content of nitrogenous compounds. The solid fraction is left with high levels of nitrogen because this element is found in low amounts in the liquid fraction. This results in a high amount of NOx emission when burning the pellets, briquettes or any solid form with this residue. Also, and as additional information, when NOx is emitted it has an unpleasant odor, which is part of the odor generated by pollutants when incinerated, such as heavy metals and high concentrations of ash.

Another procedure and a plant for the treatment of slurry comprises: (ii) carrying out a physical-chemical treatment on the liquid phase of the slurry to reduce the emission of ammonia contained in said slurry during the evaporation step, by means of stripping or fixation by acidification; (ii) subjecting the liquid stream resulting from step (i) to vacuum evaporation until obtaining a solids concentrate containing between 20% and 30% by weight of solids; and (iii) drying the solids concentrate from step (ii) until obtaining a product with a maximum moisture content of 12% that is useful as organic fertilizer, or enriched with a fertilizing ammonium salt.

Products and processes for waste derived from different types of slurry are also known, for example, as a biomass composition, where this composition includes: (i) a lignocellulosic material; and (ii) at least one member selected from the group consisting of potassium, sodium, and chlorides, wherein said at least one member comprises no more than about 0.01% (by weight) of said composition. The composition may not include more than 10% water.

Processes are also known for converting waste fibers into solid fuel, which includes the supply of animal waste, including the waste fibers, in a predetermined amount; flushing the animal waste supplied during a predetermined flushing period; dewatering the animal waste supplied by removing water from the waste fibers for a predetermined dewatering period; detachment of the waste fibers to separate liquids from solids; compressing the dried and separated waste fibers to generate a plurality of briquettes; roasting at least one of the plurality of briquettes in a roasting reactor using a heat source at a predetermined roasting temperature for a predetermined roasting period; withdrawing from the reactor at least one of the plurality of briquettes; and cooling the roasting reactor to reach a predetermined cooling temperature.

Methods and devices are known for producing fuel pellets from wet biomass of any kind, where the biomass is shredded, mechanically dehydrated, dried, and then processed into pellets, where the shredded product is finely shredded and/or the biomass is washed either before or after the shredding, optionally with water extracted from the mechanical dehydration, and is optionally pre-dehydrated and/or heated before the mechanical dehydration step, and optionally ground again after mechanical dehydration by simple drying.

Processes that use ultrasound as a step in the separation of components are also known For example, a method is known to produce a clean energy material from agricultural and forestry residues, producing a solid lignocellulosic material. The method comprises the steps of decomposition and separation of the solid lignocellulosic material from agricultural and forestry residues and the production of clean energy material. The material is fed into the system (step a)) via a screw conveyor, the interior of which is in communication with a chamber comprising an ultrasound generator that generates ultrasound vibrations in the presence of water (steps (b) and c)), causing the material to lose its microstructure, and in this state the material is subjected sequentially, with stirring, to primary crushing, dilaceration and liquid-solid separation (step (d)), compression and separation of components (step (e)) and finally the production of dry lignocellulosic material (steps f) and g)). On the other hand, as a summary, this patent includes in its process the expansive explosion of vapor, microwaves, heating, a number of extra chemical and biological processes, such as decomposition of cellulose. Finally, the product of this process is mixed with coal dust to obtain a product with a high calorific value.

Another example in line with sonication is a method for processing biomass to obtain ethanol from plant residues. Where biomass (for example, plant biomass, animal excrement biomass, and municipal waste biomass) is processed to produce useful products such as fuels. For example, the systems may use as feed materials such as cellulosic or lignocellulosic, and/or starch- or sugar-containing materials to produce ethanol and/or butanol by fermentation, for example. In such examples, it is known that sonication breaks the lignin and cellulose bonds, creating bubbles that burst in the medium containing the lignin and cellulose, in order to better expose the residues from the bursting to biological processes. When the bubbles burst, which can occur in less than a nanosecond, the implosive force increases the local temperature inside the bubble to approximately 5100° K and generates high pressures. It also indicates that these materials are sonicated with a frequency range of 16 kHz to 110 Khz. These high temperatures and pressures break the bonds in the material. It also shows a general system in which a stream of cellulosic material mixes with a stream of water in a tank to form a process stream, where a first pump draws the process stream from the tank and directs it to a flow cell. The ultrasonic transducer transmits ultrasonic energy, causing the described physical-chemical process. It is also stated that, upon separation, the solid material dries and can be used as an intermediate fuel product.

Document DE 1020014116250 also proposes a method for treating a mixture of at least one liquid phase and at least one solid phase, in particular liquid manure or sewage sludge, comprising the steps of: a) generating an ultrasound field (5.1b-5). nb); b) transporting the mixture through the region of the ultrasonic field; c) treating the mixture with ultrasound in the region; and d) separating the mixture into the liquid phase and the solid phase after ultrasonic treatment. It also proposes that a suitable apparatus be available to carry out the process and use the solid phase generated by the process or apparatus. The objective of this method in general is to decrease the water content for the solid part between 1.8% to 3%, increasing the amount of nitrogen in the solid to make it a good fertilizer.

On the other hand, other examples employed more of a chemical separation. One such example includes a treatment system for wastewater containing biological waste through electrocoagulation and electro-oxidation, which consists of the inclusion of slurry into a a slurry pit by means of a pumping system, where it is exposed to a solid/liquid separator or filter press. The process consists of sending the solids to a storage container to be dried through exposure to the open air or artificially to obtain soil fertilisers, while the liquids are sent to a flotation-flocculation tank. In this flotation-flocculation tank, sludge is generated that is sent to the filter-press, from which it is mixed with the solids coming from the storage tank, while the liquid matter is passed through electrocoagulation equipment for separation from the floating sludge, from the precipitated sludge and the clarified water that is sent to a tank. The floating sludge is transferred by decantation to the filter press, while the precipitated sludge is purged, and the treated water goes through a process where caustic soda is added to increase the pH and thus be included in an electro-oxidation step.

Procedures are known for producing fuel from organic waste. In one example, a process is used for producing fuel from liquid hydrocarbons from organic medical waste materials based on distillation treatments, through distillation towers or cracking towers. The procedure consists of preparing a suspension from the waste materials to form a stream, the volume of which stream accumulates in a stirred vessel. Subsequently, the stream is heated to a temperature between approximately 60-700° C. and a pressure between 20-600 psi to decompose solid organic materials and inorganic materials separately.

In other procedures, fuel is formed from livestock waste using a procedure comprising: (i) forming a mixture having a number of solid components derived from livestock waste and a second waste product different from said livestock waste, where the solid components have a moisture content before said formation step, and where the mixture formed has a lower moisture content than the solid content, and (b) forming the mixture resulting from step (a) into a self-supporting body having a density close to approximately 20-40 pounds/ft3. In summary, this patent presents a traditional solid/liquid separator by screw or screening which about 40% to 60% of sawdust is added to make a pellet, where this product retains all the contaminants from its source residue, such as high concentration of ash, heavy metals, high concentrations of nitrogen, among others.

Procedures are known for the mechanical separation of the liquid and solid components of manure used as a raw material to produce fuel pellets. It is known for example, that said pellet contains approximately 25%-75% by weight of cellulosic material (cellulose, lignin and hemi-cellulose); and approximately between 14%-75% by weight of waxed cellulosic material, which corresponds to lignocellulose to which a layer of wax was added. Specifically, the process disclosed mixes 42% of manure, with 40% of sawdust, cotton, jute, etc. and the remaining percentage with paper, cardboard, or another derivative of paper.

Another process is known to produce fuel pellets from an initial mixture made up of liquid and solid components, where said method consists of the following steps: separating the solid and liquid components, extracting energy from the liquid components and drying the solid constituents. The extraction of energy from the liquid components is based on a fermentation step.

A process is also known for producing biomass and sugar pellets from cellulosic material. In general, it describes a process of extraction of sugars from wood through hot water and/or vapor, followed by fermentation. It is a process to increase the calorific value of wood by eliminating the cellulose, to make it similar to the calorific value of coal and thus be able to replace it, since a coal-fired boiler loses 60% of its calorific capacity if firewood is used.

Humanity from the beginning of time to the present has used the burning of dung as fuel. However, it is known that this causes various health problems. WHO estimates suggest that up to 6.5% of the annual disease burden in developing nations is due to the indoor burning of solid fuels (Combustion of dried animal dung as biofuel results in the generation of highly redox active fine particulates, Particle and Fibre Toxicology 2005, 2:6, 4 Oct. 2005).

It is relevant to indicate that the smell produced by the direct burning of dung is a very important factor since it permeates clothes, homes and entire environments, in addition to the obvious environmental problems that this causes.

It is also relevant to point out that the purpose of using the dry products or by-products of the aforementioned processes, in general, only points to the production of solids for burning or power generation. However, ligno-cellulosic material, as a by-product, can also be used as a reactant in processes that do not lead to the destruction of the by-product for power generation, thus being a way of recovering a waste with a higher added value.

In addition to the health problems and costs already described, there are technical problems when using this type of fuel without any prior treatment. In boilers, corrosion of the steel is observed regardless of its origin (normal steel, chrome steel, stainless steel). It is possible to observe a corrosion of 8 mm per year.

This problem also occurs with biomass derived from animal fodder, leaves and tree branches, since chlorine is fixed in the leaves, bark and in all fast-growing crops.

Due to the diet of ruminant animals, which feed mainly on grasses, their digestive process uses cellulose and hemicellulose as a source of sugars, leaving lignin as waste, which is indigestible, but with a calorific value of approximately 5500-6500 Kcal/kg.

### BRIEF DESCRIPTION OF THE FIGURES

FIG. 1 is a block diagram illustrating operation of a system for treating biological waste known in the art.

FIG. 2 is a block diagram illustrating operation of an example of a system for treating biological waste as described in the present disclosure.

FIG. 3 is a schematic diagram illustrating operation of an example washing system for use in the system for treating biological waste shown in FIG. 2.

FIG. 4 is a schematic diagram illustrating structure and operation of examples of cavitation components for use in the system shown in FIG. 3.

FIG. 5 is a schematic diagram illustrating examples of angles of collision and flow of jets exiting from two impingement ducts shown in FIG. 4.

FIG. 6 depicts an example of a hammer mill screw device that may be implemented in example implementations.

### DETAILED DESCRIPTION OF THE DEVELOPMENT

### Detailed Description

It should be understood that the present development is not limited to the particular methodology, methods, systems, composite products, materials, manufacturing techniques, uses and applications described herein, as these may vary. It should also be understood that the terminology used herein is employed for the sole purpose of describing a particular embodiment and is not intended to limit the scope and potential of the present development.

It should be noted that the method, system, product, and use, here, in the claims and throughout the text that the singular does not exclude the plural, unless the context clearly implies so. So, for example, the reference to a “use or method” is a reference to one or more uses or methods and includes equivalents known to those skilled in the art. Similarly, as another example, a reference to “a step”, “a stage” or “an embodiment” is a reference to one or more steps, steps or embodiments and may include implicit and/or supervening sub-steps, steps, or embodiments.

All the conjunctions used must be understood in the least restrictive and most inclusive sense possible. Thus, for example, the conjunction “or” must be understood in its orthodox logical sense, and not as an exclusive “or”, unless the context or the text expressly requires or indicates so. The structures, materials and/or elements described must also be understood to refer to functionally equivalent ones in order to avoid endless exhaustive enumerations.

The expressions used to indicate approximations or conceptualizations must be understood in this way unless the context mandates a different interpretation.

All names and technical and/or scientific terms used herein have the common meaning given by a common person, qualified in these matters, unless otherwise expressly indicated.

Methods, techniques, elements, compounds, and compositions are described, although similar and/or equivalent methods, techniques, compounds, and compositions to those described may be used or preferred in the practice and/or testing of the present invention.

All patents and other publications are incorporated as references, with the purpose of describing and/or informing about, for example, the methodologies described in said publications, which may be useful in relation to this disclosure. These publications are included only for the information they contain prior to the filing date of this patent application.

The following concepts are defined to provide clarity to this development:

Cavitation or vacuum suction: for the present development, the cavitation process is understood as a hydrodynamic effect that occurs when vapor cavities are created within water or any other liquid fluid in which forces are acting in response to pressure differences, as can happen when the fluid passes at high speed along a sharp edge, producing a decompression of the fluid due to the conservation of Bernoulli's constant. The vapor pressure of the liquid may reach a level such that the molecules that compose it immediately change to the vapor state, forming bubbles or, more correctly, cavities. The bubbles formed travel to areas of higher pressure and implode (the vapor suddenly returns to the liquid state, abruptly “squashing” the bubbles) producing a high-energy gas trail on a solid surface that implodes, cracking it upon impact.

The implosion causes pressure waves that travel through the liquid at speeds close to the speed of sound, regardless of the fluid in which they are created. These pressure waves can dissipate in the stream of liquid, or they can impact upon a surface. If the area on which the pressure waves collide is the same, the material tends to weaken structurally and begins to erode, which, in addition to damaging the surface, the area becomes an area of greater pressure loss and therefore an area that enhances the formation of vapor bubbles. If the vapor bubbles are near or in contact with a solid wall when they implode, the forces exerted by the liquid crushing the cavity left by the vapor give rise to very high localized pressures, causing pitting on the solid surface. Note that depending on the composition of the material used, this could lead to oxidation, with the consequent deterioration of the material.

Biomass: for purposes of this disclosure, biomass shall be understood to mean the waste products of animal metabolic processes, especially those of cattle and pigs, and other elements used for their diet. The term “biomas” can also be understood in the context of this disclosure as the waste product of a bioreactor, which has a high content of ash (heavy metals, silica, among others), a high nitrogen content, a high Sulphur content, among other parameters that will be mentioned below in the application example.

Slurry: the terms “manure”, “slurry” and “dung” are used to refer to livestock feces. The particular difference between these terms is largely unimportant for purposes of this disclosure. “Slurry” typically refers to material collected in a pond or slurry pit, while the terms “manure” and “dung” are more generic, often referring to material having a water content that is lower than that found in a slurry pit. The terms “manure” and “slurry” also do not imply any specific reference to the manner in which the material is stored or contained.

It is noted that the manner of collecting and storing the manure does not affect or change the method described or the quality of the solid lignocellulose biofuel obtained from it.

Regulations: refers generally, unless stated otherwise, to compliance with the limit parameters of standard ISO 17225-6, and also to the specific parameters of each of the analyses carried out for this development.

Silica: refers to silicon oxide, sand, and its derivatives, generally between 7% to 12% of dry bovine feces.

Nitrogen: shall be understood to mean, for purposes of this disclosure, any nitrogenous material that exists in the aforementioned animal waste, formed broadly by urea nitrogen, such as uric acid and ammoniacal nitrogen.

The subject matter of the present disclosure relates to methods, systems, and a product and by-product for synthesis (or intermediate product) that may be obtained from the treatment of slurry that allows for obtaining the greatest amount of lignocellulose as a raw material and/or fuel, the largest amount of cellulosic material as a product for burning and the by-product for synthesis, and for both, having a minimum amount of contaminants, a minimum amount of silica related to the ash residue, and a minimum amount of nitrogen. The procedure uses organic waste from livestock, which consists of feces and urine and/or slurry. Systems and methods described herein also operate with significant energy savings based on the use of energetically passive sub-steps during washing, which are described below.

The subject matter of the present disclosure also corresponds to a method for the treatment of manure that leads to obtaining a high-quality fuel product that efficiently replaces the use of firewood and coal in boilers, whether for residential or industrial use.

For purposes of this disclosure, the term “Quality” shall mean a high standard of efficiency, through a greater amount of kcal/kg, a lower emission of toxic gases, a lower generation of ash-well below the lower limits imposed by standard ISO 17225-6, which indicates between 6% to 10% w/w as combustion ash residue, with a lower production of silica as combustion residue, with a lower presence of nitrogen derivatives, as well as having a low energy consumption production process that is harmonious with current environmental standards such as caring for the environment, helping to reduce environmental pollution, decreasing gas emissions, improving the sanitary status of livestock companies, and recycling the liquids and solids involved in the process, reusing them efficiently.

The solid fuel product disclosed herein may be obtained through the treatment of slurry or manure to obtain derivatives with lignin or lignocellulose as raw material and/or fuel using examples of the systems and methods described below.

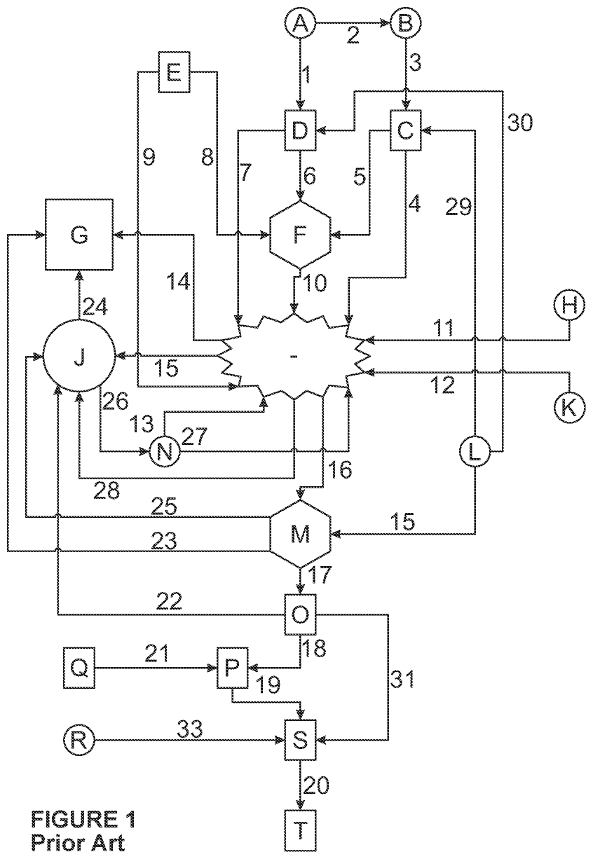

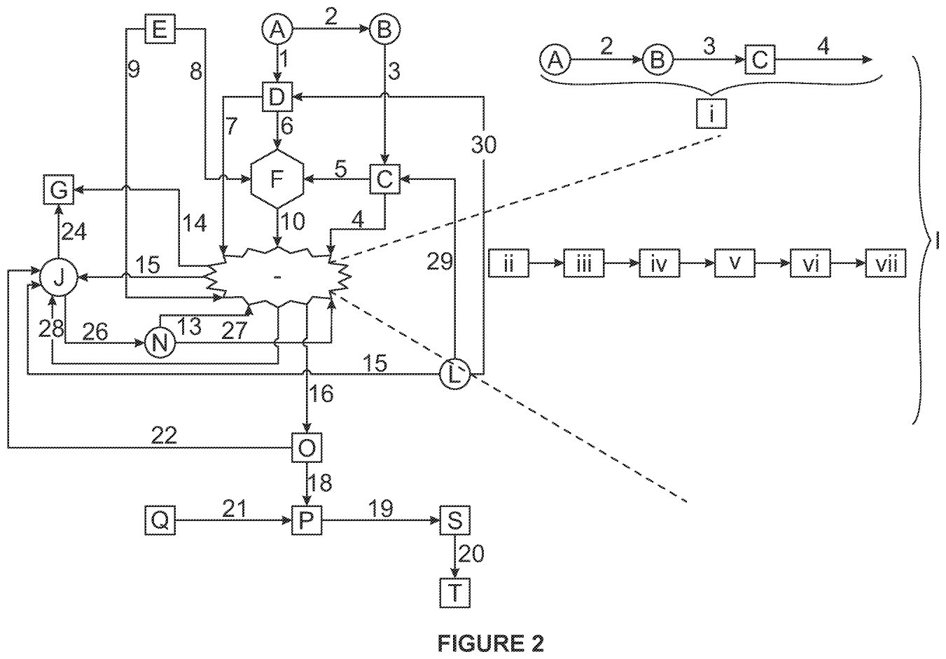

Examples of the washing system of the present disclosure may be incorporated in other systems and methods for obtaining a solid fuel product from livestock manure, such as for example, systems and methods such as those described in patent application PCT/CL2017/00009. FIG. 1 is a block diagram illustrating an example of the system disclosed in patent application PCT/CL2017/00009. FIG. 2 is a block diagram illustrating operation of an example of a system for treating biological waste as described in the present disclosure. Example implementations of the washing system are described below with reference to FIGS. 1 and 2 for a washing system implemented using the system of patent application PCT/CL2017/00009. It is noted that the illustrated implementations represent only one example of the type of system in which the washing system described herein may be implemented. The example washing systems described herein may be implemented in a wide variety of systems for producing biofuel products from livestock manure.

A slurry pit is defined as a pool that collects cattle feces and urine. Likewise, it can be composed of other elements, such as those present in cattle bedding (straw and sawdust), residues from biodigesters or bioreactors, digestates, pieces of rubber from rubber blankets, rubber, wood shavings, plant husks, such as from rice, chemical products, sand, cattle feed remains, and water, among many others.

Referring to FIGS. 1 and 2, a slurry may be fed into the system from one or more slurry pits (A) using a variety of feeding methods. The slurry pits (A) may have a capacity in the range of between 200 m³ and 10,000 m³, preferably 700 m³, in one example implementation, although the slurry pit (A) may be any suitable size. One example feeding method includes transporting the slurry from the slurry pit or pool (A) via a passage (1) to a typical screw conveyor (D), which may have a capacity for moving wet solid material (for example material having approximately 95% humidity) at between about 150 and 600,000 kg/h, preferably between 250 and 30,000 kg/h. It is noted that any specifications set forth in this disclosure are provided for purposes of illustration and are not intended to limit the scope of the subject matter in any way. The screw conveyor (D) may provide a slight filtering of liquid, where the solid may remain at between 70% and 85% humidity. The solid may optionally be pre-washed with clean water (L), with a flow rate in the range of between 10 and 1000 liters/min in the step (30), that is provided through the upper part of the conveyor screw (D). Optionally, the solid may be provided at step (6) for grounding using a hammer mill or simple shredder (F) that leaves the solid having a particle size in a range of between 5 and 20 mm, and then further provided at step (10) to a washing system (I). If the slurry is transported directly from a channel that supplies the slurry pit at a rate of about 250 to 30,000 kg/h and has an average humidity of 70% to 85%, or if the slurry is sufficiently liquid and does not contain hard dung, the slurry passes via step (7) directly to the washing system (I).

In one alternative implementation for feeding the slurry to the system at step (2), a slurry pump (B) having a flow rate of 80 kg/min to 14,000 kg/min takes the slurry from the slurry pit (A) and impels the slurry through a hose via step (3), which provides the slurry to a typical liquid and solid separator (C). The liquid and solid separator (C) may have a capacity of between 100 to 1000 kg/min, preferably 285 kg/min, and is configured to receive clean water (L) through passage (29), where the clean water (L) is sourced externally from springs or sources without contaminants. The slurry that has been separated by the liquid and solid separator (C) can be directed through two independent flows, at step (4) and at step (5). Step (4) provides the slurry directly to the washing system (I). Step (5) delivers the slurry to the hammer mill or simple shredder (F) to eliminate lumps. The slurry then follows through step (10) to the washing system (I).

Another way to feed the system involves a slurry pile (E), which may be formed by waste from the liquid and solid separators (C) for example, or from slurry pits and/or biogas plants and/or dung accumulation. Slurry from the slurry pile (E) may proceed at step (8) to the hammer mill or simple shredder (F) and via step (10) to the washing system (I). The slurry from the slurry pile (E) may also proceed via step (9) directly to the washing system (I).

Any of the above-described alternatives for feeding the system ultimately delivers the slurry to the washing system (I). It is noted that the above-described alternatives are describe as non-limiting examples. Other ways to feed the system may be used. For example, another alternative includes digestates directly from a biodigester or a bioreactor.

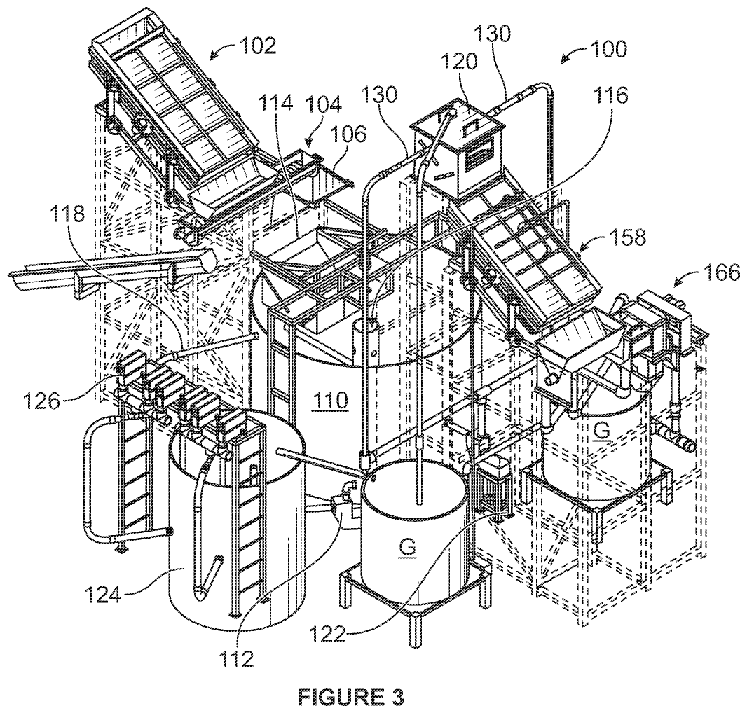

Referring to FIG. 3, the washing system 100 comprises different associated devices and steps that cooperate with one another. If the slurry pit (A) (in FIG. 1) releases slurry in sufficiently liquid, uniform conditions and without major lumps, the first device is the slurry pump (B), which is included in the system because initial impulsion of the slurry is required. The slurry pump (B) preferably pumps or moves the slurry with a humidity in the range between 80% to 95%, preferably between 84% and 90%, with a percentage of dry matter between 9% to 12% w/w using any of the previously mentioned forms of slurry feeding.

The slurry is moved to an initial filtering device, or livestock manure filter, which may be, for example, a screen, sieve, or rotary filter 102. The filter may be optionally configured to vibrate, with a filter mesh size of 10 US mesh (2 mm) up to 40 US mesh (0.4 mm), preferably 20 US mesh (0.841 mm), which filters and separates a more homogeneous solid product than that provided by previously mentioned sources of slurry delivery, with a humidity range from 70% to 90% w/w, preferably 83% w/w.

The screen type device refers to a flat mesh optionally vibrating to improve water run-off, positioned in the range of 30° to 60°, preferably at 45°, with a filter mesh size as mentioned above. On the other hand, the sieve type device alternative corresponds to a mesh circumscribed to a frame that can optionally vibrate to better extract the water, arranged at a negative inclination. The rotating filter type device corresponds to a rotating cylindrical mesh which filters the flow that passes through it. Several of these rotary filters can be arranged in series or in parallel and be washed with external jets of clean water. Both the shaking and rotary types of filters maintain the same mesh size mentioned above.

From the screen, sieve or rotary filter type device 102, the retained solid falls by gravity into a feeder screw device 104, which is a common solids drive screw with a material displacement capacity between 500 to 2000 kg/hr., preferably 1000 kg/hr., with which the solid is moved to feed a dosing device 106 that makes portions and standardizes the amount of solid, between 500 kg/h up to 7000 kg/h, preferably 1000 kg/h to enter the next device. In this step, the humidity of the product is between 60% and 35%, preferably 45% w/w. The dosing device 106, may be, for example, a basket, screw, rocker, which generally corresponds to a system for regulating the dosage of the material with a required pressure. The dosing device 106 may be a preprogrammed funnel-type bucket that releases its content when it reaches a pre-programmed weight. The dosing device 106 may include an electro-mechanical control system for the dosage and release of the material to be measured.

Once the dosing device 106 is filled, it releases its content into the washing and humidification tank 110 through a solids entry point 108. The washing and humidification tank 110 hydrates and homogenizes the previously filtered solid and brings it to a humidity between 85% and 99% by weight, preferably 97% by weight. The washing and humidification tank 110 comprises: a tank with a capacity between 5 and 100 m³, preferably 35 m³, with an inlet for the washing water 112, which can be above or below the tank, and through this inlet is optionally injected ozone (O₃), and another point of entry of the solid 114 to be treated. The washing and humidifying tank 110 also includes, in the center, a tubular paddle agitator device 116 that, when it rotates, generates a centripetal effect from the rotating movement that sucks the mixture from below the tank into its interior and releases it through the upper part of the tube, where the washing water from the first injection 112 may also be used to generate a stream that drags the solid, separating it in combination with the previously mentioned centripetal movement effect. Alternatively, the contents of the washing and humidification tank 110 can simply be centrifugally agitated from the center through paddles with the respective washing water from the first inlet 112, generating a torrent that drags and separates the solid. After this, if there is excess liquid in the washing and humidification tank 110, it is expelled through a level transfer outlet 118, in the upper part of the washing and humidification tank 110, transferring the content back to the slurry pit or tank (A).

The washing and humidification tank 110 also fulfils the function of homogenizing and degassing the excess Ozone (O₃), after which and continuing with the process, the transfer of solids is channeled directly from the washing and humidification tank 110 to a cavitation and shock tank 120 by means of cavitator feed pumps 122 with a flow capacity, per cavitator, between 100 and 3000 L per minute, preferably 800 L per minute per cavitator, with powers between 2 and 50 Kw, preferably and by way of example without wanting to restrict other capacities of the system, 4 Kw/h to be able to process between 400 and 1500 kg/hour of slurry with a range between 85% and 99% humidity on dry basis, preferably 90%, preferably 97%, preferably 98%, preferably 99%, preferably to process 500 kg/h of fibers. To produce the ozone-water mixture, it is prepared in an attached ozone preparation tank 124, where ozone is bubbled through ozone-generating machines 126 into a volume of water (J) between 1000 L/h up to 320,000 L/h, preferably 100 to 14,000 L/min, preferably 1,000 L/min.

Referring to FIG. 2, the origin of the continuous flow of water (J), where the water (J) that enters the washing and humidification tank 110 after passing through the attached ozone preparation tank 124 (in FIG. 3), is driven by a liquid drive pump (N) that enters via step (13) upper inlet, and step (27) lower inlet, which come from the liquid drive pump (N) which is supplied by step (26), coming in turn from the accumulator and purifying tank (J), which is supplied by step (28), and by step (15) that comes from the filtrates of the entire washing system (I). For its part, the purification and accumulation tank for washing water (J) generates a flow that is represented by the step (24), and which feeds the tank with biological material concentrate and inert impurities (G), which will be treated to be left as compost. Likewise, the aforementioned biological material concentrate, and inert impurities tank(s) (G) are also fed by the liquid waste generated by the final granulometric filtering 158, the gases bubbled from the cavitation and shock tank 120 (in FIG. 3) and a hammer mill screw assembly 166 (in FIG. 3), which corresponds to step 14, as can be seen in FIGS. 2 and 3.

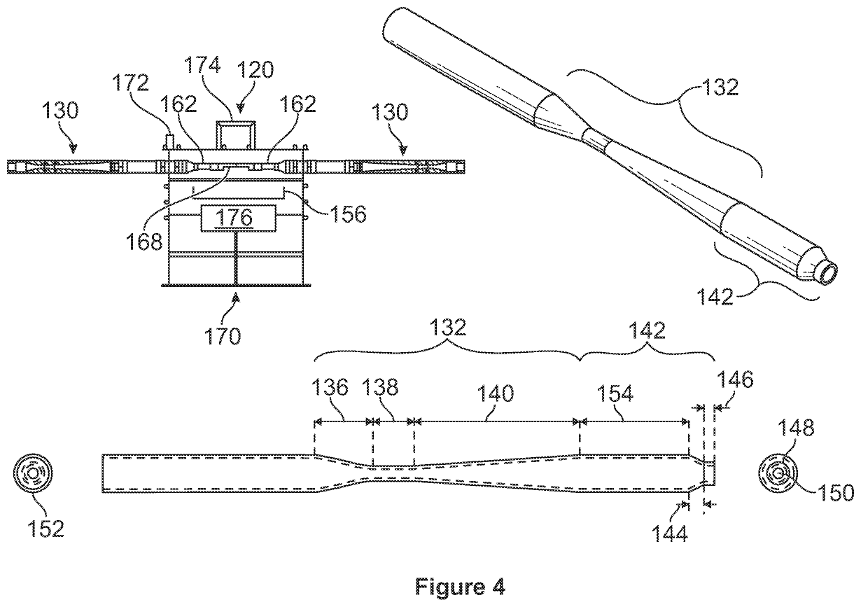

The number of cavitator feed pumps 122 is proportional to the number of jets through which the liquid to be treated passes through cavitation ducts 130. Therefore, a jet that passes through a cavitation duct 130 must be driven by a pump or several jets with greater power. The cavitation ducts 130 can operate in series or in parallel, depending on the layout of the system, it can be one or “n” depending on the amount of product to be processed. In one example, one cavitation duct or preferably two cavitation ducts are used. The cavitation and shock tank 120 comprises a series of components as described further with reference to FIG. 4.

Referring to FIG. 4, the cavitation ducts 130 comprise two main structures connected to one another, the cavitation and laminar flow duct 132 and a shock duct 142. The cavitation and laminar flow duct 132 comprises a tubular-shaped structure with tapered internal and external diameters (external decreases are optional), with an internal diameter between 4 cm to 22 cm, preferably 6 cm, preferably 11 cm, with a total length between 50 cm and 280 cm, preferably 75 cm, preferably 137 cm. The materials with which this duct is made include different types of abrasion and oxidation resistant metals, such as steel and alloys, they can also be polymers, such as polyamide, among others, or there can be a combination of materials in the same duct.

Internally, the cavitation duct 130 comprises three sections, ordered from the inlet for the waste flow to the outlet in the final granulometric filtering (vi). First, the cavitation duct 130 is fed from the washing and humidification tank 110 passing through the cavitator feed pump(s) 122, where these residues enter through the diameter of an inlet duct 152 in a first nozzle section 136 in which the internal diameter of the cavitation duct 130 is reduced with a nozzle angle of between 15° and 35°, preferably 21°. This reduction in an internal diameter 150 of the cavitation duct 130 ranges from a slight reduction in the inlet internal diameter of the cavitation duct 130 to ⅕ of the internal diameter, preferably ⅓.

This section has a length between 7 cm and 41 cm, preferably 107 cm, preferably 110 cm. Reducing the diameter of the duct in this section rapidly increases the flow rate of the fluid at a constant inlet pressure.

Following the flow of the residue, next comes a second flow load section 138, which maintains a constant internal diameter in relation to the tapering in the internal diameter of the previous section, where this flow load section 138 comprises a length between 4 and 23 cm, preferably 6 cm, preferably 11 cm. In this section a high flow rate is maintained at a constant pressure.

Continuing with the conduction of the fluid, comes a third and last section of the cavitation and laminar flow duct 132, which is a diffuser 140 where the internal diameter of the cavitation duct 130 is widened again at an angle between 5° and 10°, preferably 7°, until reaching the same inlet diameter 152 of the cavitation duct 130, where the length of this section ranges from 22 cm to 124 cm, preferably 33 cm, preferably 49 cm. In this section, the cavitation effect is produced because when the fluid comes with a high flow rate (high speed) and passes through the edge of the angle that is formed when the diameter of the duct expands, a sudden pressure drop is generated, which generates microbubbles in the fluid and their coalescence, managing to agitate the fibers, agglomerates and particles mixed in the fluid, preferably silica particles, preferably waste derived from nitrogen, Sulphur derivatives, heavy metal derivatives such as cadmium, mercury, lead among others, and waste fibers. In this section and depending on the differences in the flows (relative velocities of the fluid) formed, the inlet pressure to the cavitation duct 130 can go from a constant pressure to 25% of that pressure in milliseconds, preferably 50%, by way of example, and without limiting other ranges, from 4 ATM (atmospheres) to 0 ATM of pressure at the outlet of this section. The process carried out in the cavitation duct 130, does not consume energy, and achieves, through a physical process, efficient separation of the fibers, the silica, and the rest of the components of the treated waste in order to deliver a pre-processed product to the final granulometric filter 158, so that it, in turn, achieves maximum cleanliness.

Then, and continuing with the flow direction, a second element called the shock duct (g2b) 142 is connected, which communicates directly with the cavitation duct 130 and delivers its pre-processed product to the impingement of flows. This shock duct (g2b) 142 comprises three sections, where the first section maintains the same internal diameter of the inlet 150 to the cavitation duct 130 and is called a separation section 154, where the flow is partly retained, maintaining a laminar flow and a physical space is provided for the component elements of the waste to be separated. This section comprises a length of 14 cm to 76 cm, preferably 20 cm, preferably 30 cm.

The second section of the shock duct (g2b) 142, in the direction of the flow, corresponds to an outlet reduction section 144, where the inlet diameter 152 is reduced to a larger diameter 148 with respect to the reduction diameter 150 of the flow load section 138, in the range of between 45% and up to slightly less than the internal diameter of the cavitation duct 130, preferably by 50%; the length of this section it is between 2 cm and 11 cm, preferably 3 cm, preferably 5 cm. The angle of reduction in this section is of the order of between 25° and 35°, preferably 30°. This section, despite the reduction in the diameter of the duct outlet (148, induces a reduced pressure, so it does not generate greater resistance and additional pressure variations.

Finally, the last section before washing the residue is an outlet section 146, which can be directed and will guide the outlet jet of the residue to the final granulometric filter 158. This section maintains the reduced diameter of the previous section and has a length of between 1 cm and 7 cm, preferably 2 cm, preferably 3 cm.

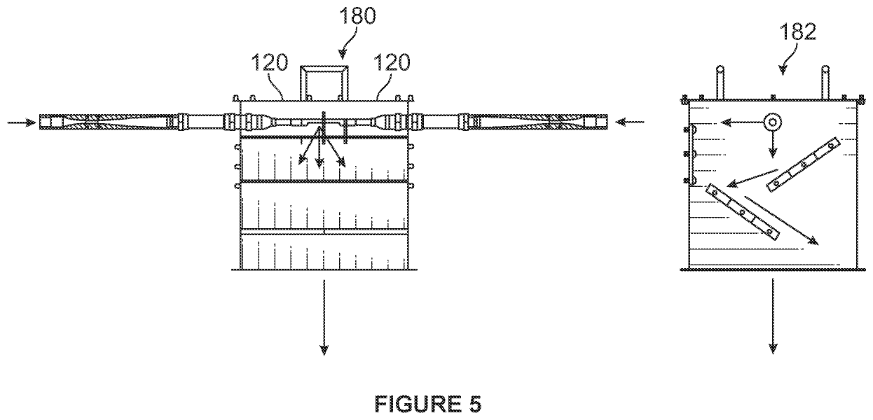

Inside the cavitation and shock tank 120 two output jets are made to collide with each other, or an output jet against one of the walls of the tank, or against a sheet or deflector from shock ducts 142, where the direction of the collision between jets is preferably frontal, although it can be angled if there are more than two jets, at a distance of between 1 cm and 200 cm, preferably 2 cm, preferably 10 cm, preferably 50 cm, preferably 100 cm, preferably 150 cm, where the ability to shred the fibers of the jets is indirectly related to the distances between the shock ducts 142, in other words, the smaller the distance, the greater the shredding. To improve the frontal impingement of two jets, an optional part is presented, which makes the two shock ducts 142 face one another, called the steering and shock tube 156, which consists of a tube with the same diameter as the shock duct outlet 142 but with two lateral perforations 162 and one lower central perforation 168 that fulfil the objective of channeling the explosion of the jet as shown in FIG. 5. The output flow of the shock ducts 142 is of the laminar type and is in the range of 20 liters per minute to 5000 liters per minute, preferably 500 liters per minute. By way of example and without restricting the development, if the flows from two cavitation ducts 130 with two shock ducts 142, individually with flow rates of 500 liters per minute, collide, they add their speeds in the impingement and together, the flow rate for washing is 1000 liters per minute.

Cavitation and flow impingement generate an unexpected effect in the present development, which consists in that externally applied oxidizing species such as O₂ and O₃ react chemically with subspecies derived from nitrogen, Sulphur, and other pollutants, partly volatilizing this nitrogen, Sulphur and other contaminants, as volatile elements in combination with oxygen, thus removing part of this contaminant from the end product. In order to eliminate these volatile contaminants, the cavitation and shock ducts 120 also includes a gas outlet duct 172 in its upper part that channels and bubbles the gases in the biological material concentrate and inert impurities tank (G) in order to enrich this residue with the dissolved gases generated in the cavitation and shock ducts 120 in step 14.

The cavitation and shock tank device also includes a product outlet 170 from the flow impingement, a handle 174 for maintaining the cavitation ducts and a viewer 176 for verifying the operation of the device. In general, the product that comes out of the impingement has a humidity in the range between 85% and 99% w/w on a dry basis, preferably 90% w/w, 98% w/w and 99% w/w. FIG. 5 is a front view 180 and side view 182 of the cavitation and shock tank 120 showing the angle of collision of the jets coming out of two shock ducts 142 and how jets behave when material leaves the device 120.

By gravity, the product resulting from the impingement of flows falls and is positioned on a wet solid filter, or a final granulometric filter device 158, that corresponds to a final device such as a screen, sieve, or rotary filter 158, which can optionally vibrate, with a filtering mesh size of between 0.25 to 2 mm (10 to 60 US mesh). The final filter 158 filters and separates a more homogeneous and finer solid product than the one delivered by the previously mentioned cavitation and shock ducts 120, with a humidity range between 70% and 90%, preferably 83%, where the moistened fibers are retained and the liquid with its respective contaminants is filtered a second time. This device is arranged at an angle that ranges from 10° above the horizontal to 80° above the horizontal, preferably 45°. For this second filtration, the screen, sieve, and rotary filter type devices are similar to those described for the first granulometric filter. On the other hand, the solid retained in this final filter can be sprayed with recycled water (J) or clean water (L) before passing to the next device.

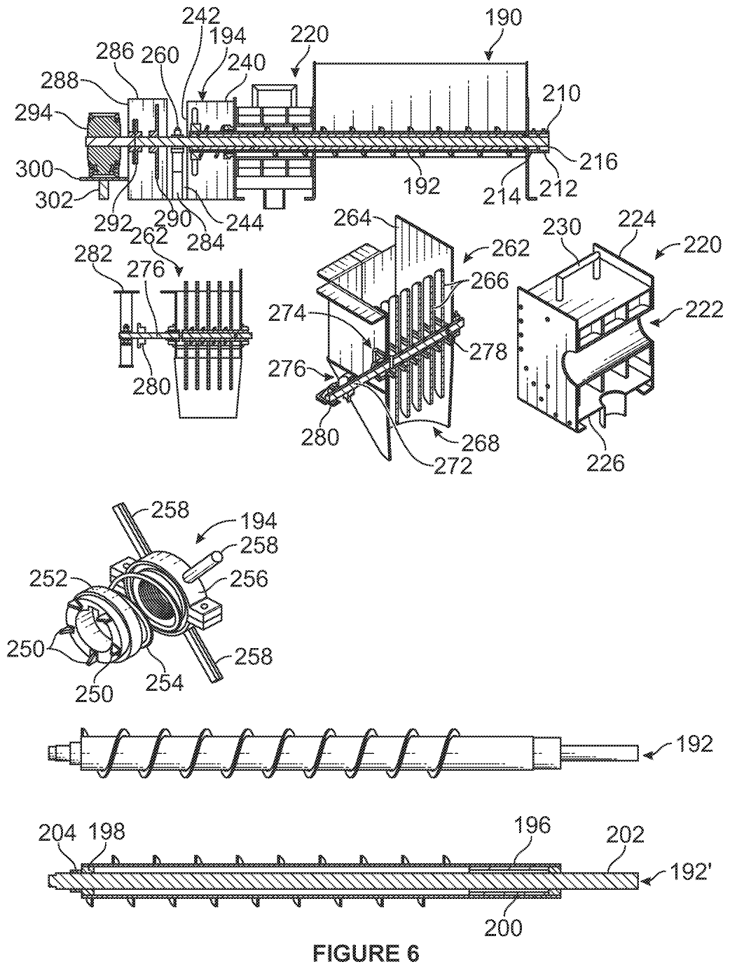

Finally, and continuing with the handling of solid products, the solid that falls from the shock of the flows, mentioned above, may be deposited by gravity into a hammer mill screw assembly 166, an example of which is shown in FIG. 6.

FIG. 6 illustrates the hammer mill screw assembly 166 as well as the components of the hammer mill screw assembly 166 separate from the assembly 166. Referring to FIG. 6, the hammer mill screw assembly 166 is a compact piece of equipment that operates with two elements: an extruder mill element and a grinding element. The first element, the extruder mill element, includes the following: an inlet hopper 190, a screw shaft 192, and a tightening system 194.

The washed wet solid falls by gravity to the inlet hopper 194, where the solid is channeled via a screw shaft 192 to move the solid against the tightening system 194. FIG. 6 shows a front view of the screw shaft 192 and below the front view, a transparent front view 192′ illustrating component parts of the screw shaft 192. The screw shaft 192′ includes a pipe with a continuous helix 196 with a rotation angle ranging from 15° to 50°, preferably 20° and with a distance between turns of preferably 15 cm, without wanting to restrict other efficient possibilities with this measure. The screw shaft 192 also includes two pipe end bushings 198, with an internal pipe reinforcement 200, all mounted on a shaft 202, with a shaft end bushing 204. The screw shaft 192 is also supported in the extruder screw element of the hammer mill screw assembly 166 by a rear support 210 and mounted on two conical circular bearings 212 to maintain the movement of the screw shaft 192, these bearings are fastened to prevent their exit following the line of the axis, by the fastening sleeves 216, in parallel an O-ring 214 separates these bearings 212 from the incoming material in the input hopper 190.

The wet washed solid moves along the screw axis (j1) 192 towards the tightening system 194 and passes through a sieve device 220. The sieve device 220 includes a circular sieve element 222 with between 80 and 1000 slides, preferably 112, with measurements, by way of non-limiting example, of 400 mm long, 30 mm wide and 2.5 mm thick, with a mesh size of between 0.05 and 3 mm. The circular sieve element 222 is supported on a sieve support 224 and wrapped in a sieve casing 226, which fulfil the function of channeling the water extracted in the tightening and channeling it through a drain 228 to be recirculated, retaining the solid in the inner surface of the screening device 220. This sieve device 220 is easily removable by means of a sieve handle 230 for cleaning, where in addition to extracting the sieve element 222, the device cover 232 can be removed.

The above-referenced tightening system 194 comprises an area delimited by an upper cover 240, an upper side cover 242 and a lower side cover 244 that support the accumulation of solid material chopped by means of a set of blades 250 that are tightened on a blade holder 252, which in turn is stabilized on the horizontal axis by a spring 254, which in turn exerts pressure against the direction of the material via the screw shaft 192. The tightening system to hold onto the extruder mill element of the hammer mill screw assembly 166, is mounted through a lever-holder 256 that holds a plurality of levers 258, which holds the tightening system 194 to the entire device in an easy and removable way in case the blades 250 need replacing. This tightening system 194 remains in a firm position without rotating, but allows the screw shaft 192 to rotate freely, causing the retained solid to be squeezed, increasing the draining time, leaving a more dehydrated solid material.

On the other hand, the tightening system 194 compresses and shreds the solids and when they partially accumulate on the screw shaft 192 they release liquid in the sieve device 220. Most of the solids, however, fall due to pressure and gravity to a grinding assembly 262, which may be a hammer mill corresponding to the second element of the hammer mill screw assembly 166 referenced above. The grinding assembly 262 may include a support box 264 and a circular output 268 of solid material, internally it comprises a set of grinding or shredding blades 266 in the shape of a symmetrical cross mounted on a tube 270, which rotates on a square grinding shaft 272, where for this rotation, the grinding shaft 272 is positioned between two square base bearings 274 at each end of the tube outside the box. The blades rotate due to the energy delivered during the rotation of a pinion 276 and due to the pressure exerted by the solid trying to come out due to the restriction generated by a grid 278 with a mesh size slightly greater than the thickness of the blade. In order for the grinding assembly to be in position and to rotate freely on its shaft, it also contains a grinding assembly support bearing 280, which is mounted on a grinding assembly support 282.

Continuing with the extruder mill element, on the screw shaft 192, after the tightening system 194, comes the bearing 260 and a main support 284 that supports most of the hammer mill screw assembly 166. Continuing with the same arrangement, comes a pinion area, delimited by the upper cover (j19) an upper cover 286 and side covers (j21) 288, this area protects a set of large 290 and 292 small pinions mounted on the shaft 202, where the large pinion 290 provides the mechanical energy to the grinding assembly 262. After this comes a reducer motor 294 that delivers power to the entire hammer mill screw assembly 166. This motor is directly associated via a standard motor shaft 296 to the shaft 202 to deliver rotation to the entire device, with a speed between 10 to 250 rpm. By way of example, this motor can have a capacity of 10 Hp and a speed of 140 rpm, without limiting the capacity and power of the motor to this specific example. On the other hand, the motor is supported on a motor base 300 and is positioned by a motor support 302.

The efficiency of the hammer mill screw assembly 166 may be such that it begins working with solids with moisture around 85% w/w and after all the milling, pressing, shredding, and filtering processes it reaches a mixture of fibers with a humidity under 30% w/w, which results in lower energy consumption in later steps for efficient drying of the end product. Also, the size of the final fiber is in the range of 0.595-0.297 mm, considering 72% of the total sample, which provides a greater surface area for exposure to oxidants and fire in the final combustion of the product, thus improving the efficiency of the final combustion.

The solid product exits the hammer mill screw device 166 substantially more dehydrated and continues with post-washing processes that may further treat the solid product further to yield a final product. Such processes may be similar to those disclosed in the PCT patent application no. PCT/CL2017/00009.

Referring to FIG. 2, the solid material is transported through step (16) to the pressing or centrifuging section (O), which eliminates excess water from the material, which is subsequently taken through step (18) which corresponds to a dryer (P), which is fed with hot air through the passage (21) which in turn is fed by the Boiler (Q), then this material falls through the passage (19) onto a dry magnetic vibrating screening device (S) that corresponds to a sieve-type device, similar to the filter 102 of the washing system (I) described above, except dry, with magnetic bars to trap metals and a sifting mesh size of between 2 mm (10 US mesh) up to 0.595 mm (30 US mesh), which sifts and separates a fine homogeneous powder-type solid product with a moisture range of between 10% and 5%, preferably 7%, where the fragments of larger size and the sieved powder are channeled through pneumatic ducts (20) to the pelletizing process (T). This device is arranged at an angle ranging from 10° above the horizontal to 80° above the horizontal, preferably 45°.

The material that has been processed may be incorporated into the pelletizing process (T) via step (20) to finally form pellets and/or lignocellulose briquettes and/or some other solid form to be burned.

The washing systems and methods disclosed herein, in addition to cleaning all kinds of impurities from the outside of the fiber, is also capable of cleaning the fiber on the inside, which is full of bacteria, enzymes, gastric juices that are responsible for dissolving cellulose and hemicellulose to transform them into sugars, but when they leave the animal they remain inside the fiber as contaminants and when burned they emit odors and gases that are harmful to health.

The washing systems and methods disclosed herein are also capable of cleaning the inside and outside of the fiber of silica residues, thus improving the end product by eliminating its ability to vitrify inside boilers and stoves.

The process in the washing system (I) of the present disclosure includes:
1) initial and final granulometric filtering,
2) dosing,
3) centripetal or centrifugal movement,
4) water turbulence,
5) optional ozone injection,
6) cavitation,
7) impingement, and
8) hammer mill screw dehydration.

These steps may be performed in known systems and processes to achieve a double objective of (1) minimum energy consumption in the process by having sub-steps that do not consume energy, and (2) an end product of high energy power with a minimum of contaminants, especially nitrogen and ash, among others. This system may be configured to enable the release of all contaminants both inside and outside the solid components of the slurry and its mixtures in a continuous process, and provide a solid product with particular characteristics. As previously mentioned, the application of chemical agents is not contemplated nor required in the example implementations of the systems and methods described herein. The examples of the washing system (I) and method in the total performance of the system are a fundamental part of this development.

The sub-steps of the washing system process (I) may include:
i. Impulsion through the Slurry Pump (B): movement of the slurry from the slurry pit (A) moving the slurry mixture.
ii. Initial granulometric filtering: this sub step corresponds to an initial filtering by means of a screen, sieve, or rotary filter to achieve standardizing and slightly reducing the humidity of the solids being processed, in general the solids received have a humidity of less than 85% w/w. The solids obtained are transported by a screw where the percentage of humidity decreases below 80% w/w.
iii. Dosage: this sub step corresponds to measuring the weight of a quantity of solid to enter the next sub step of the process. Mainly, the weight of a quantity of solid is measured by means of an automated basket and its content is released into the washing and humidification tank (v).
iv. Centripetal or centrifugal movement with water turbulence and optional ozone injection: these are mentioned as sub-steps to be performed inside the washing and humidification tank 110. The fiber-containing mixture is rehydrated through the water inlet (J), which moves and drags the fiber-containing mixture, in parallel as a first alternative, in the center of the tank a tubular paddle agitator sucks this hydrated mixture and raises it by centripetal movement to the top of the apparatus where it spills out in the center of said tank. A second alternative is simply an agitator paddle in the center of the tank, generating a centrifugal effect in the mixture. Optionally, a mixture of water with premixed ozone can be added to the tank in order to eliminate microbiological material and compounds derived from nitrogen, compounds derived from Sulphur and other compounds from later sub-steps. For this, the ozone-water mixture is prepared in an attached ozone preparation tank 124, where ozone is bubbled through ozone generating machines 126 in a volume of water (J) between 1000 L/h up to 320,000 L/h, preferably 33,000 L/h, until reaching a concentration in the range of 900 to 1,200 ppb and this mixture, in turn, is reinjected into the washing and humidification tank 110, as previously mentioned.
v. Cavitation and shock: The liquid and solid that comes out of the washing and humidification tank 110 is raised by the previously described cavitation pumps 122 and the flow passes through the cavitation and shock tank 120. Within a cavitation duct 130, the physical reaction of cavitation occurs within the liquid and within the retained moisture contained in the fibers, generating a very high-speed micro-bubbling effect that mechanically destabilizes contaminants and different types of fibers within the mixture. The destabilized contaminants and different types of fiber may then be separated by impingement, which may be performed using different flows from different cavitation ducts 130, or using a single duct and a wall of the cavitation and shock tank 120. Cavitation and shock may in turn be separated into three phases. The first phase is cavitation of the flow. The second phase is separation and lamination of the flow. The third phase is flow impingement.
vi. Final granulometric filtering: this sub step occurs after the impingement sub-step inside or against the cavitation and shock tank 120, where the wet solid passes by gravity through a final granulometric filter 158, which corresponds to a final filtering by means of a screen, sieve or rotary filter, which retains the moistened fibers and filters the liquid with its respective contaminants a second time, in general the moistened fibers have a humidity between 80% and 85%.
vii. Dehydration by a hammer mill screw: the wet solid from the previous sub-step enters a hammer mill screw 166 with a configuration of two elements that first proceeds to push the solid and squeeze it through the extruder screw element, which dehydrates it until left with a mixture of fibers with a moisture content below 30% w/w, and then the second hammer mill element that shreds the resulting solid.

It is noted for an example implementation, the power necessary for the cavitation and shock step (v) is a cavitation pump power 122 in a range from 2 Kw to 50 Kw. In an example implementation, without limiting other capacities of other example systems, a power of 4 Kw is found to be able to process 1200 kg/h of slurry at 80% humidity or higher leaving the diluted fiber in a range of 0.5% to 5%, preferably 2%, preferably 2.5%, preferably 3%, in water, which is the ideal medium for the cavitation step with flow rates of, for example, 500 L/min passing through the cavitator tube 130. As previously mentioned, the fluid to be treated is required to have a predetermined humidity and dilution to enable operation in the cavitator tube 130, where within these parameters the ideal is a humidity of 97% and a particle size no greater than 20 mm.

After passing through the cavitation comes the separation and lamination of the flow where the flow is slowed down and its pressure is stabilized. Once the flow is stabilized and laminated, it is released by making the flows collide against each other, this means that if there are only two jets they collide in opposite directions, adding their speed; if there are more than two jets, these collisions are in pairs or in trios neutralizing the projection outside by the cavitation and shock tanks 120.

It is further noted that for an example implementation, to extract the cellulosic fibers and lignin with its derivatives, and as the final part of the washing process, step (vii) uses the hammer mill screw assembly 166. This screw is also a desiccator screw because it manages not only to move the fibers to the subsequent drying steps, but also to extract the water from the mixture from 98% to 30% w/w (the state of the art generally mentions that screws, in general, leave between 70% to 80% of moisture in the mixture), which saves time and energy when drying the fibers in later steps.

This screw can be used in other drying or moisture reduction processes regardless of the method and field of application of the present development.

To achieve these effects, the hammer mill screw assembly 166 operates at a high speed of between 20 rpm up to 200 rpm, preferably 140 rpm, preferably 70 rpm, in a small diameter and with internal fiber-breaking blades, as mentioned earlier in their description.

The particle size coming out of the hammer mill screw assembly 166 is in a low range of 0.595-0.149 mm.

With respect to the end product obtained as pellets or briquettes for burning, according to Table I it comprises:

TABLE I

| | Unit | Range |
|---|---|---|
| Higher Calorific Power | (kcal/kg) | 4200-5700 |
| Lower Calorific Power | (kcal/kg) | 4000-5300 |
| Total Humidity | (w/w %) | 1-10 |
| Ash | (w/w %) | 0-3 |
| Sulphur | (w/w %) | 0-0.2 |
| Nitrogen | (w/w %) | 0-0.5 |
| Particle Size | (mm) | 0.595-0.297 |

### PARTS LIST

FIG. 1 shows a block diagram of the state of the art of application PCT/CL2017/00009 for the treatment of slurry to obtain lignocellulose as a raw material and/or fuel and other chemical components. Operations are shown in blocks, flow lines or streams are represented with arrows which indicate flow direction and are also represented by numbers.

FIG. 2 describes a diagram with the steps of the present development and how they are partly related to steps of the previous state of the art.

FIG. 3 presents only a diagram of the component elements of the washing system (I). Where they are indicated according to their numbering:
A: slurry pit
102: initial screen, sieve or rotary filter type device
104: feeder screw device
106: dosing device
110: washing and humidification tank
112: inlet for washing water
114: entry point for the solid
116: tubular paddle agitator
118: level transfer output
G: biological material concentrate and inert impurities tank
120: cavitation and shock tanks
122: cavitator feed pumps
130: cavitation ducts
172: gas outlet duct
158: final screen, sieve or rotary filter type device
166: hammer mill screw device
126: ozone-generating machines
124: attached tank for ozone preparation
O: press or centrifuge

FIG. 4 shows the cavitation and shock tank 120, its cavitation duct (g2a) 132, the relationship of its internal components, between the cavitation and laminar flow duct 132 and the shock duct 142 and its different parts. The numbers indicate:
120: cavitation and shock tank
130: cavitation ducts
132: cavitation and laminar flow duct
136: first nozzle section
138: flow load section
140: diffuser section
152: inlet duct diameter
150: internal diameter reduction
142: impingement duct
154: separation section
144: output reduction section
146: output section
148: top diameter
162: side perforations
168: central bottom perforation
156: steering and impingement tube
170: product output
174: handle
176: viewer
172: gas outlet duct

FIG. 5 shows the angle of collision of the jets coming out of two shock ducts 142 and how they behave when they leave the device.

FIG. 6 shows the hammer mill screw assembly 166, showing all its parts and pieces, where the numbers indicate:
192: screw shaft
196: pipe with helix
198: pipe end bushings
200: internal pipe reinforcement
202: shaft
204: shaft end bushing
210: rear support
212: circular bearings
214: o-ring
216: clamping sleeves
190: input hopper
220: sieve device
222: circular sieve element
226: sieve casing
224: sieve support
232: device cover
230: sieve handle
228: drain
194: tightening system
252: blade holder
256: lever holder
254: spring
258: lever
250: blades
260: bearing
290: large pinion
292: small pinion
294: reducer motor
296: standard motor shaft
262: grinding assembly
266: symmetrical cross-shaped grinding blades
268: circular output for solid material
264: support box
274: square base bearings
280: grinding assembly support bearing
276: grinding assembly pinion
278: grid
272: square grinding shaft
270: tube
302: motor support
284: main support
282: grinding assembly support
300: motor base
286: upper cover of the pinion area
244: lower side cover of the tightening system
288: side covers of the pinion area
240: upper cover of the tightening system
242: upper side cover of the tightening system

### EXAMPLE OF APPLICATION

This example was developed in the slurry pits of the Las Garzas agricultural laboratory.

On Aug. 17, 2020, 5450 kg of mainly bovine slurry were used and the procedure of the present development was applied. The cleaning water used comes from a well in the area, with water with a high content of dissolved salts.

Slurry and manure samples were taken initially, delivering the following summary of analytical results, as shown in Table II:

TABLE II

| | Unit of | | |
|---|---|---|---|
| Parameter measured | measurement | Slurry pit | Manure |
| Higher Calorific Power | (kcal/kg) | 3,376 | 3,571 |
| Lower Calorific Power | (kcal/kg) | 3,107 | 3,277 |
| Lignin | (%) | 2.4 | 24.7 |
| Cellulose and hemicellulose | (%) | 4.5 | 45 |
| Particle size | (mm) | NS | 10-0.595 (67% |
| | | | of particles) |
| Total Humidity | (%) | 89.21 | 9.13 |
| Ash | (%) | 18.5 | 26.57 |

RAW MATERIAL COMPOUNDS

| | | | |
|---|---|---|---|
| Sulphur | (%) | 0.3563 | 0.3598 |
| Carbon | (%) | 40.76 | 42.98 |
| Hydrogen | (%) | 5,242 | 5,687 |
| Nitrogen | (%) | 1.797 | 2.908 |
| Oxygen | (%) | NS | NS |
| Mn (Manganese) | (ppm) | 130.43 | 166.45 |
| As (Arsenic) | (ppm) | <0.01 | <0.01 |
| Pb (Lead) | (ppm) | <0.01 | <0.01 |
| Cu (Copper) | (ppm) | 29.63 | 42.47 |
| Cr (Chromium) | (ppm) | 6.95 | 10.95 |
| Cd (Cadmium) | (ppm) | 1.042 | 0.89 |
| Mo (Molybdenum) | (ppm) | 4,866 | 7.42 |
| Hg (Mercury) | (ppb) | 1.2 | 1.0 |
| Ni (Nickel) | (ppm) | 2.829 | 6,818 |
| V (Vanadium) | (ppm) | 11,121 | 4,113 |
| Co (Cobalt) | (ppm) | 0.547 | 0.348 |
| Zn (Zinc) | (ppm) | 70,056 | 121,442 |
| Sb (Antimony) | (ppm) | <0.01 | <0.01 |

ASH COMPOUNDS

| | | | |
|---|---|---|---|
| SiO₂ | (%) | NS | 1.23 |
| Other compounds | (%) | | 22.42 |
| TOTAL | (%) | NS | 23.65 |

After passing the slurry through this process, the final pellet of the same was also sampled, delivering the following analytical results, according to Table III.

TABLE III

| | Unit of | |
|---|---|---|
| Parameter measured | measurement | Pellets |
| Higher Calorific Power | (kcal/kg) | 4,550 |
| Lower Calorific Power | (kcal/kg) | 4,219 |
| Lignin | (%) | 35.6 |
| Cellulose and hemicellulose | (%) | 62.7 |
| Particle size | (mm) | 0.595-0.297 (72% |
| | | of particles) |
| Total Humidity | (%) | 6.96 |
| Ash | (%) | 1.7 |

RAW MATERIAL COMPOUNDS

| | | |
|---|---|---|
| Sulphur | (%) | 0.14 |
| Carbon | (%) | 50.23 |
| Hydrogen | (%) | 5.97 |
| Nitrogen | (%) | 0.44 |
| Oxygen | (%) | NS |
| Mn (Manganese) | (ppm) | 51 |
| As (Arsenic) | (ppm) | <0.01 |
| Pb (Lead) | (ppm) | 12.2 |
| Cu (Copper) | (ppm) | 13.23 |
| Cr (Chromium) | (ppm) | 3.13 |
| Cd (Cadmium) | (ppm) | <0.01 |
| Mo (Molybdenum) | (ppm) | 7.42 |
| Hg (Mercury) | (ppb) | 1.2 |
| Ni (Nickel) | (ppm) | 2.98 |
| V (Vanadium) | (ppm) | 2.03 |
| Co (Cobalt) | (ppm) | <0.01 |
| Zn (Zinc) | (ppm) | 29.49 |
| Sb (Antimony) | (ppm) | <0.01 |
| Cl (Chlorine) | (ppm) | 70 |

ASH COMPOUNDS

| | | |
|---|---|---|
| SiO₂ | (%) | 1.21 |
| Other Compounds | (%) | 19.29 |
| TOTAL | (%) | 20.5 |

For the comparative calculation of the reduction of Silicon, it should be noted that the percentage of Silicon varies fundamentally in relation to the percentage of Ash, and the latter with respect to the total product.

The following processes were used for the analyses under international standard conditions as shown in Table IV.

TABLE IV

| Test | Methods |
|---|---|
| Sample preparation | UNE-CEN/TS 14780 EX Applicable: solid |
| | biofuels |
| Ash | UNE-EN 14775 |
| Elemental analysis (C, | EN 15104 |
| H, N) | Applicable: solid biofuels |
| Sulphur content | EN 15289 |
| | Applicable: solid biofuels |
| Determination of major | UNE EN 15290 |
| elements in biomass by | |
| ICP-OES (Ca, Al, Mg, K, | |
| Na, Si, P, Ti, S, Fe) | |
| Determination of | UNE EN 15297 |
| minority elements | |
| in biomass by ICP-OES | |
| (Cr, Cu, Zn, Pb, As, Mo, | |
| V, Mn, Ni, Cd, Co, Sb) | |
| Sample digestion (for | UNE EN 15290 |
| majority and minority | |
| elements) | |
| Determination of | UNE-EN 15297, December 2011 Applicable: |
| minority elements in | Solid biofuels I-L-094, based on the |
| biomass by Hydride | Manual of the AAS AAnalyst 400 |
| Generation AAG Arsenic | (quantification) equipment |
| Determination | |
| Determination of minor | UNE-EN 15297, December 2011 Applicable: |
| elements in biomass by | Solid biofuels (digestion) I-L-089, |
| Cold Vapor AAS | Determination of Mercury by Cold Vapor |
| Determination of | Atomic Absorption Spectroscopy |
| Mercury | |

The following Table VIII shows the analyses performed on the reactants and products of the patent application by the same inventor PCT/CL2017/00009.

TABLE VIII
STANDARDS USED

| | | |
|---|---|---|
| ASTM | Standard Practice for | http://www.astm.org/Standards/D3172.htm |
| D3172-13 | Proximate Analysis of | |
| | Coal and Coke | |
| ASTM D4239 - | Standard Test Method | http://www.astm.org/Standards/D4239.htm |
| 14e2 | for Sulfur in the | |
| | Analysis Sample of | |
| | Coal and Coke Using | |
| | High-Temperature | |
| | Tube Furnace | |
| | Combustion | |
| ASTM D4239 - | Standard Test Method | http://www.astm.org/Standards/D4239.htm |
| 14e2 | for Sulfur in the | |
| | Analysis Sample of | |
| | Coal and Coke Using | |
| | High-Temperature | |
| | Tube Furnace | |
| | Combustion | |
| UNE-EN | Solid biofuels. | http://www.aenor.es/aenor/normas/normas/fichan |
| 14774-1: 2010 | Determination of | orma.asp?tipo=N&codigo=N0045726#.VxD5C6jh |
| | moisture content. | DIU |
| | Oven drying method. | |
| | Part 1: Total humidity. | |
| | Reference method. | |
| UNE-EN | Solid biofuels. Method | http://www.aenor.es/aenor/normas/normas/fichan |
| 14775: 2010 | for the determination | orma.asp?tipo=N&codigo=N0045971#.VxEDa6jh |
| | of ash content. | DIU |
| UNE-EN | Solid biofuels. | http://www.aenor.es/aenor/normas/normas/fichan |
| 14918: 2011 | Determination of | orma.asp?tipo=N&codigo=N0046857#.VxD8Bqjh |
| | calorific value. | DIU |
| UNE-EN | Solid biofuels. | http://www.aenor.es/aenor/normas/normas/fichan |
| 15104: 2011 | Determination of total | orma.asp?tipo=N&codigo=N0048348#.VxD8X6jh |
| | carbon, hydrogen and | DIU |
| | nitrogen content. | |
| | Instrumental methods. | |
| UNE-EN | Solid biofuels. | http://www.aenor.es/aenor/normas/normas/fichan |
| 15104: 2011 | Conversion of | orma.asp?tipo=N&codigo=N0048440#.VxD- |
| | analytical results from | GqjhDIU |
| | one base to another. | |
| UNE-EN | Solid biofuels. | http://www.aenor.es/aenor/normas/normas/fichan |
| 15148: 2010 | Determination of | orma.asp?tipo=N&codigo=N0045972#.VxD5hajh |
| | volatile matter content | DIU |
| UNE-EN | Solid biofuels. | http://www.aenor.es/aenor/normas/normas/fichan |
| 15289: 2011 | Determination of total | orma.asp?tipo=N&codigo=N0048352#.VxEGcqjh |
| | sulphur content. | DIU |
| UNE-EN | Solid biofuels. | http://www.aenor.es/aenor/normas/normas/fichan |
| 15296: 2011 | Determination of | orma.asp?tipo=N&codigo=N0048507#.VxD2xqjh |
| | minority elements. As, | DIU |
| | Cd, Co, Cr, Cu, Hg, | |
| | Mn, Mo, Ni, Pb, Sb, V | |
| | and Zn | |
| UNE-EN | Solid biofuels. | http://www.aenor.es/aenor/normas/normas/fichan |
| 15297: 2011 | Determination of the | orma.asp?tipo=N&codigo=N0048352#.VxD4tKjh |
| | total content of minor | DIU |
| | elements, mercury, | |
| | and arsenic | |

Particle size was measured under standard EN 15149-1, by the transfer of particles through different sieves and the weight of the material retained in each one for the product that was being measured, in order to calculate the majority percentage retention for a range of particle sizes.

The measurement of lignin, cellulose and hemicellulose was carried out based on standard ASTM D-1106.

As can be seen by comparing the results of Tables II and III, the step of the washing system achieves toxicity parameters (referring to the chemical elements that can produce risks) that are much lower than those already known, also, in the final pellet silica, particle size and nitrogen levels are achieved that are extremely lower than those of origin.

Regarding the process, apart from having more efficient steps with respect to washing the fiber and the end product, energy consumption is unusually lower compared to the state of the art with respect to particle size. This is due to the use of energetically passive steps for the fiber washing process. This can be verified comparatively in the following Table V:

TABLE V
Power of installed process equipment

| | kW Installed power | | Operating kW | |
|---|---|---|---|---|
| | PCT/ | | PCT/ | |
| ITEMISED | CL2017/ | Development | CL2017/ | Development |
| SECTION | 00009 | Process | 00009 | Process |
| Purine pump (B) | 4 | 4 | 3 | 3 |
| Traditional | 4 | 0 | 3 | 0 |
| Extruder Screw | | | | |
| (F) | | | | |
| Gutter | 0 | 0 | 0 | 0 |
| Agitator Tank | 4 | 0 | 3 | 0 |
| Screen 102 | 0 | 0.25 | 0 | 0.1875 |
| Traditional | 2 | 2 | 1.5 | 1.5 |
| Extruder Screw | | | | |
| 104 | | | | |
| Dispenser 106 | 0.5 | 0.5 | 0.375 | 0.375 |
| Humidifier 110 | 0.75 | 2 | 0.5625 | 1.5 |
| Cavitating | 0 | 4 | 0 | 3 |
| Impingement 120 | | | | |
| Ultrasound | 8 | 0 | 6 | 0 |
| Ultrasound tank | 2.5 | 0 | 1.875 | 0 |
| Screen or Sieve | 0 | 0.25 | 0 | 0.1875 |
| 158 | | | | |
| Rotary Separator 1 | 1 | 0 | 0.75 | 0 |
| IBC 1 | 2.2 | 0 | 1.65 | 0 |
| Rotary Separator 2 | 1 | 0 | 0.75 | 0 |
| IBC 2 | 2.2 | 0 | 1.65 | 0 |
| Flocculation tank | 2.2 | 0 | 1.65 | 0 |
| Water Tank | 2.2 | 2.2 | 1.65 | 1.65 |
| Ozone 126 | 2 | 2 | 2.25 | 2.25 |
| Hammer mill screw | 0 | 7.5 | 0 | 5,625 |
| 166 | | | | |
| Traditional Screw | 4 | 0 | 3 | 0 |
| Total | 44 | 26 | 33 | 19 |
| Percentage | 75% | 30% | 75% | 30% |
| moisture in | | | | |
| Biomass Output | | | | |

| | | |
|---|---|---|
| Percentage | 59% | 59% |
| decrease in | | |
| Power kW | | |

As can be seen, the decrease in energy by the new development is verified as 59%, with a 40% decrease in the percentage of water in the end product obtained.

When analyzing the result above, we consider that the cavitation and subsequent impingement steps are passive steps of lower energy consumption with respect to the ultrasound indicated in the state of the art. On the other hand, the hammer mill screw dehydration step is highly efficient in dehydrating the fibers, leading to a lower energy consumption in the dryer. The product can be compared before the dryer operation of application PCT/CL2017/00009, where the humidity range was between 65% to 75% w/w; on the other hand, the current humidity range handled before the dryer is in the range of 30% to 35% w/w. If you add to this a smaller average particle size range for the current product, it results in almost 71% less energy consumption by the dryer.

On the other hand, to verify the energy efficiency of the hammer mill screw 166 of this process, the efficiency of the device with respect to its energy consumption was verified, as seen in Table VI:

TABLE VI
Screw hammer mill performance per 100 kg expressed in dry matter

| | | | | heat energy to | heat energy to |
|---|---|---|---|---|---|
| % Moisture | | | kW necessary to | evaporate water | evaporate water |
| in slurry | Kilos of | Litres | obtain 100 kg dry | from 10° C. in | from 10° C. in |
| sample | Dry Matter | of water | matter (motor power) | Kcal | kW |
| 90% | 100 | 900 | 0.05 | 570,780 | 664 |
| 85% | 100 | 567 | 0.08 | 360,990 | 420 |
| 80% | 100 | 400 | 0.54 | 255,780 | 297 |
| 75% | 100 | 300 | 1.00 | 192,780 | 224 |
| 70% | 100 | 233 | 1.46 | 150,570 | 175 |
| 65% | 100 | 186 | 1.91 | 120,960 | 141 |
| 60% | 100 | 150 | 2.37 | 98,280 | 114 |
| 55% | 100 | 122 | 2.83 | 80,640 | 94 |
| 50% | 100 | 100 | 3.29 | 66,780 | 78 |
| 45% | 100 | 82 | 3.74 | 55,440 | 64 |
| 40% | 100 | 67 | 4.20 | 45,990 | 53 |
| 35% | 100 | 54 | 4.66 | 37,800 | 44 |
| 30% | 100 | 43 | 5.12 | 30,870 | 36 |
| 25% | 100 | 33 | 5.58 | 24,570 | 29 |
| 20% | 100 | 25 | 6.00 | 19,530 | 23 |
| 15% | 100 | 18 | | 15,120 | 18 |
| 10% | 100 | 11 | | 10,710 | 12 |
| 5% | 100 | 5 | | 6,930 | 8 |
| 0% | 100 | — | | | 0 |

Table VI shows the great convenience of using the hammer mill screw, because the state of the art discloses, in general, screws that obtain 75% humidity in the end product at a power of 1 kW for every 100 kg of dry matter, which means that 300 liters of water have to be evaporated with an caloric energy cost of 224 kW to obtain the dry matter. The high efficiency hammer mill screw 166 achieves a range of between 30% and 35% moisture in the material with 5.12 kW of power per 100 kg of product at equivalent dry matter and with a quantity of 43 liters of water to evaporate which is equivalent to 36 kW of heat energy. This means that the high efficiency hammer mill screw 166 in this case obtains a caloric energy saving of 184.12 kW.

Finally, a comparative chemical analysis of the pellets produced by the process closest to the state of the art (PCT/CL2017/00009) and the pellets produced by the present development was carried out, as can be seen in the following Table VII:

TABLE VII

| | | | Solid-liquid | Product | Product |
|---|---|---|---|---|---|
| | | | separation | obtained | obtained |
| | | | according to | through | through the |
| | | | Publication | application | process of the |
| Parameter | Unit of | Dung or Raw | Number WO | PCT/CL2017/ | present |
| measured | measurement | Material | 2015086869 A1 | 00009 | development |
| Higher Calorific | (kcal/kg) | 3,906 | 3,602 | 4,545 | 4,550 |
| Power | | | | | |
| Lower Calorific | (kcal/kg) | 3,639 | 3,350 | 4,228 | 4,219 |
| Power | | | | | |
| Lignin | (%) | 24.7 | NS | 28 | 35.6 |
| Cellulose and | (%) | 45 | NS | 67.97 | 62.7 |
| hemicellulose | | | | | |
| Particle size | (mm) | 10-0.595 (67% | NS | 2-0.595 (84% | 0.595-0.297 (72% |
| | | of particles) | | of particles) | of particles) |
| Total Humidity | (%) | 8.58 | 6.18 | 6.52 | 6.96 |
| Ash | (%) | 24.13 | 24.55 | 4.03 | 1.7 |

RAW MATERIAL COMPOUNDS

| | | | | | |
|---|---|---|---|---|---|
| Sulphur | (%) | 0.29 | 0.21 | 0.11 | 0.14 |
| Carbon | (%) | 37.76 | 36.45 | 46.62 | 50.23 |
| Hydrogen | (%) | 5.14 | 4.84 | 6.07 | 5.97 |
| Nitrogen | (%) | 2.35 | 0.91 | 0.61 | 0.44 |
| Oxygen | (%) | 29.99 | 32.98 | 41.17 | NS |
| Mn (Manganese) | (ppm) | 295 | 245 | 78.81 | 51 |
| As (Arsenic) | (ppm) | <50 | <50 | <50 | <0.01 |
| Pb (Lead) | (ppm) | <50 | <50 | <50 | 12.2 |
| Cu (Copper) | (ppm) | 109 | <50 | <50 | 13.23 |
| Cr (Chromium) | (ppm) | <50 | <50 | <50 | 3.13 |
| Cd (Cadmium) | (ppm) | <50 | <50 | <50 | <0.01 |
| Mo (Molybdenum) | (ppm) | <50 | <50 | <50 | 7.42 |
| Hg (Mercury) | (ppb) | 1.0 | NS | NS | 1.2 |
| Ni (Nickel) | (ppm) | <50 | <50 | <50 | 2.98 |
| V (Vanadium) | (ppm) | 55 | 75 | <50 | 2.03 |
| Co (Cobalt) | (ppm) | <50 | <50 | <50 | <0.01 |
| Zn (Zinc) | (ppm) | 131 | 53 | <50 | 29.49 |
| Sb (Antimony) | (ppm) | <50 | <50 | <50 | <0.01 |
| Cl (Chlorine) | (ppm) | 3445.88 | 740.63 | 100 | 70 |

ASH COMPOUNDS

| | | | | | |
|---|---|---|---|---|---|
| SiO₂ | (%) | 2.93 | 7.02 | 2.89 | 1.21 |
| Other Compounds | (%) | 53.18 | 53.98 | 45.75 | 19.29 |
| TOTAL | (%) | 56.11 | 61 | 48.64 | 20.5 |

Based on the results shown above, we show below in Table I the ranges for higher calorific value, lower calorific value, total humidity and relevant toxic compounds expected from the product generated by the method of the present development:

TABLE I

| | Unit | Range |
|---|---|---|
| Higher Calorific Power | (kcal/kg) | 4200-5700 |
| Lower Calorific Power | (kcal/kg) | 4000-5300 |
| Total Humidity | (w/w %) | 1-10 |
| Ash | (w/w %) | 0-3 |
| Sulphur | (w/w %) | 0-0.2 |
| Nitrogen | (w/w %) | 0-0.5 |
| Particle Size | (mm) | 0.595-0.297 |

Where (w/w %) corresponds to percentage in dry weight.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A method for washing a slurry comprising a livestock manure to obtain a solid fuel comprising lignocellulose from a biological material obtained from livestock manure, the method comprising:
feeding the slurry comprising livestock manure into a washing and humidification tank;
providing rotational movement aided by a water turbulence within the washing and humidification tank to yield a liquid and solid mixture;
cavitating the liquid and solid mixture to yield a washed wet solid product; and
dehydrating the washed wet solid product to yield the solid fuel product.

13. The method of claim 12 where the step of dehydrating the washed wet solid product includes:
filtering the washed wet solid product to separate the washed wet solid product from contaminant-containing liquid after the step of cavitating and shocking the partially washed wet solids.

14. The method of claim 12 where the step of dehydrating the washed wet solid product includes:
dehydrating the washed wet solid product using a hammer mill after the step of cavitating and shocking.

15. The method of claim 12 where the step of providing rotational movement within the washing system includes injecting an ozone gas into the water turbulence.

16. The method of claim 12 further comprising:
passing the solid fuel product through a vibrating screening device after the step of dehydrating the washed wet solid product to yield the sold fuel product as a fine homogeneous powder-type solid product.

17. The method of claim 12 where the step of feeding the treated slurry to the washing and impingement tank includes pumping the treated slurry using a slurry pump.

18. The method of claim 17 where the step of feeding the treated slurry to the washing and impingement tank includes passing the pumped slurry using a liquid and solid separator.

19. The method of claim 12 where the step of cavitating further comprises:
using a cavitator feed pump to deliver the liquid and solid mixture to a cavitation tank, where the cavitator feed pump is configured to provide a pressure drop of at least one ATM with respect to an inlet pressure at the cavitation tank.

20. The method of claim 12 further comprising:
using a cavitation and shock tank configured to generate a shock in the flow of liquid and solid mixture by either:
generating one or more flows in opposite directions to provide the shock by collision of the one or more flows; or
generating a flow against a plate or a tank wall; and
configuring the cavitation and shock tank to provide a distance between opposing flows or between the flow against the plate that is as small as possible within a range of about 1 cm. to about 200 cm.

21. The method of claim 12 where the step of dehydrating the washed wet solid product includes compressing the washed wet solid product between an extruder mill element and disintegrating the washed wet solid product using the hammer mill.

22. The method of claim 12 where the step of dehydrating the washed wet solid product includes drying the wet solid product to yield the solid fuel product as a powder.

23. A washing system in a system for obtaining a solid fuel comprising lignocellulose based on biological material from the livestock manure, comprising:
a washing and humidification tank configured to receive a slurry comprising the livestock manure providing rotational movement aided by a water turbulence to yield a liquid and solid mixture;
a cavitation and shock tank configured to receive the liquid and solid mixture from the washing and humidification tank, where the cavitation and shock tank is configured to generate a flow, and to cavitate and shock the flow of the liquid and solid mixture to reduce the particulate size of the liquid and solid mixture without the use of ultrasound to yield a washed wet solid product.

24. The washing system of claim 23 further comprising a cavitation pump configured to deliver the liquid and solid mixture from the washing and humidification tank by providing a pressure drop of at least 1 ATM with respect to an inlet pressure at the cavitation and shock tank within milliseconds.

25. The washing system of claim 23 where the cavitation and shock tank is configured to generate a shock in the flow of liquid and solid mixture by:
generating one or more flows in opposite directions to provide the shock by collision of the one or more flows;
generating a flow against a plate; and
configuring the cavitation and shock tank to provide a distance between opposing flows or between the flow against the plate that is as small as possible within a range of 1 cm. to 200 cm.

26. The washing system of claim 23 further comprising:
a pump configured to feed the livestock manure to the washing system; and
a solids and liquid separator to provide the slurry comprising the livestock manure from the solid separated from the livestock manure.

27. The washing system of claim 23 further comprising a livestock manure filter configured to receive the livestock manure and to filter liquid to at least partially dehydrate the livestock manure to yield the slurry comprising the livestock manure.

28. The washing system of claim 23 further comprising a wet solid filter configured to receive the washed wet solid product from the cavitation and shock tank and further dehydrate the washed wet solid product allowing contaminant-containing liquid to be removed from the washed wet solid product.

29. The washing system of claim 23 further comprising a hammer mill assembly configured to extrude and disintegrate the washed wet solid product, where the extruded and disintegrated solid is further processed to obtain a solid fuel as an organic powder or in other solid forms.

30. A solid fuel product based on livestock manure, comprising:
lignocellulose, with an average particle size between 0.595-0.297, total nitrogen in percent dry weight between 0-5% w/w;
total moisture by dry weight of 1-10% w/w;
a high calorific power of 4200-5700 kcal/kg according to regulations UNE-EN 14918: 201 1;
a low calorific power of 4000-5300 kcal/kg according to regulations UNE-EN 14918: 201 1;
dry weight ash of 0-3% w/w; and
dry weight sulfur of 0-0.2% w/w.

31. The solid fuel product based on livestock manure, according to claim 30, where the solid fuel product is compacted in different forms, including, but not limited to, briquettes, pellets, or another high-density mold.
